(19) United States
(12) Patent Application Publication
(10) Pub. No.: US 2019/0354781 A1
(43) Pub. Date: Nov. 21, 2019

(54) METHOD AND SYSTEM FOR DETERMINING AN OBJECT LOCATION BY USING MAP INFORMATION

(71) Applicant: GM GLOBAL TECHNOLOGY OPERATIONS LLC, Detroit, MI (US)

(72) Inventors: Wei Tong, Troy, MI (US); Yang Yang, Sterling Heights, MI (US); Brent N. Bacchus, Sterling Heights, MI (US); Shuqing Zeng, Sterling Heights, MI (US)

(21) Appl. No.: 15/982,186

(22) Filed: May 17, 2018

(51) Int. Cl. G06K 9/00; G01C 21/30; G05D 1/02

(52) U.S. Cl. CPC G06K 9/00805; G01C 21/30; G05D 1/0276; G05D 1/0246; G05D 1/0219

(57) ABSTRACT

A system and method for determining an object location by using map information is disclosed. The method includes receiving, by a controller, an image data of a scene. An object is located within the scene. The method also includes determining, by the controller, a location of the object based on the image data of the scene. The method can also include receiving, by the controller, a map information. The map information includes at least one path information. The method also includes determining an association between the location of the object based on the image data and the map information of the scene. The method also includes determining a 3-dimensional location of the object based on the determined association.

### INTRODUCTION

The subject embodiments relate to determining an object location by using map information. Specifically, one or more embodiments can be directed to determining an object location by using imagery of the object along with the map information, for example.

Control systems can use a variety of techniques to determine the presence of surrounding objects and the location of the surrounding objects. For example, autonomous vehicles can use control systems to determine the presence and location of surrounding vehicles. In one example, a control system can capture two-dimensional imagery of the surrounding objects, and the control system can use computer vision technology to analyze the captured imagery in order to determine the presence and location of the surrounding objects.

### SUMMARY

In one exemplary embodiment, a method includes receiving, by a controller, an image data of a scene. An object is located within the scene. The method also includes determining, by the controller, a location of the object based on the image data of the scene. The method also includes receiving, by the controller, a map information. The map information includes at least one path information. The method also includes determining an association between the location of the object based on the image data and the map information of the scene. The method also includes determining a 3-dimensional location of the object based on the determined association.

In another exemplary embodiment, the controller corresponds to a vehicle controller.

In another exemplary embodiment, the method also includes segmenting the at least one path information into a plurality of path segments.

In another exemplary embodiment, determining the association between the location and the map information includes associating the location to at least one path segment.

In another exemplary embodiment, the map information includes directional-path information, and the determining the association between the location of the object and the map information is based on the directional-path information.

In another exemplary embodiment, the method also includes determining a velocity vector of the object. Determining the association between the location of the object and the map information is based on the velocity vector of the object.

In another exemplary embodiment, determining the association includes calculating a dot product between the velocity vector of the object and a directional vector of a segment of the at least one path information.

In another exemplary embodiment, determining the association between the location and the map information includes removing at least one path segment from consideration of being associated with the location. The removed at least one path segment is a path segment that is located outside of the scene.

In another exemplary embodiment, determining the association between the location of the object and the map information of the scene includes associating the location of the object to a location within the map information.

In another exemplary embodiment, the location within the map information includes the location within 3-dimensional space.

In another exemplary embodiment, a system within a vehicle includes an electronic controller configured to receive an image data of a scene. An object is located within the scene. The controller is also configured to determine a location of the object based on the image data of the scene. The controller is also configured to receive a map information. The map information includes at least one path information. The controller is also configured to determine an association between the location of the object based on the image data and the map information of the scene. The controller is also configured to determine a 3-dimensional location of the object based on the determined association.

In another exemplary embodiment, the electronic controller corresponds to a vehicle controller.

In another exemplary embodiment, the electronic controller is further configured to segment the at least one path information into a plurality of path segments.

In another exemplary embodiment, determining the association between the location and the map information includes associating the location to at least one path segment.

In another exemplary embodiment, the map information includes directional-path information, and determining the association between the location of the object and the map information is based on the directional-path information.

In another exemplary embodiment, the controller is further configured to determine a velocity vector of the object. Determining the association between the location of the object and the map information is based on the velocity vector of the object.

In another exemplary embodiment, determining the association includes calculating a dot product between the velocity vector of the object and a directional vector of a segment of the at least one path information.

In another exemplary embodiment, determining the association between the location and the map information includes removing at least one path segment from consideration of being associated with the location. The removed at least one path segment is a path segment that is located outside of the scene.

In another exemplary embodiment, determining the association between the location of the object and the map information of the scene includes associating the location of the object to a location within the map information.

In another exemplary embodiment, the location within the map information includes the location within 3-dimensional space.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a system that uses captured imagery of an object to determine the location of the object in accordance with the conventional approaches;

FIG. 2 illustrates difficulties encountered by the conventional approaches when determining the location of the object;

FIG. 3 illustrates technical difficulties encountered by the conventional approaches when attempting to determine the location of the object by using the captured imagery of the object;

FIG. 4 illustrates associating path segments (of map information) with the location of an object (as reflected by the captured imagery) in accordance with one more embodiments;

FIG. 5 illustrates using a velocity vector of the object in order to associate a path segment (of map information) with an object location (as reflected by the captured imagery) in accordance with one or more embodiments;

FIG. 6 illustrates using lane-direction information (of map information) to associate a path segment (of map information) with the object location (as reflected by the captured imagery) in accordance with one or more embodiments;

FIG. 7 illustrates correcting the velocity vector of the object in accordance with one or more embodiments;

FIG. 8 illustrates correcting the location of the object (as reflected within the map information) in accordance with one or more embodiments;

FIG. 9 illustrates a process for determining the location of an object by using map information, in accordance with one or more embodiments;

FIG. 10 depicts a flowchart of a method in accordance with one or more embodiments; and

FIG. 11 depicts a high-level block diagram of a computing system, which can be used to implement one or more embodiments.

### DETAILED DESCRIPTION

The following description is merely exemplary in nature and is not intended to limit the present disclosure, its application or uses. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments are directed to a system and method for determining an object location by using map information. The system can be used by a host vehicle to estimate a location of a neighboring/target vehicle, for example. With the conventional approaches of determining a location of an object by a vehicle system, the vehicle system would typically capture the object with 2-dimensional imagery and then perform analysis of the imagery in order to detect the presence and location of the object. However, the conventional approaches generally cannot accurately determine the object locations, particularly when the objects are located further away from the host vehicle.

In view of the difficulties encountered by the conventional approaches in determining the locations of objects, one or more embodiments can utilize map information in order to determine the locations of objects. By using map information to determine the location of an object, one or more embodiments can more accurately determine the object's location.

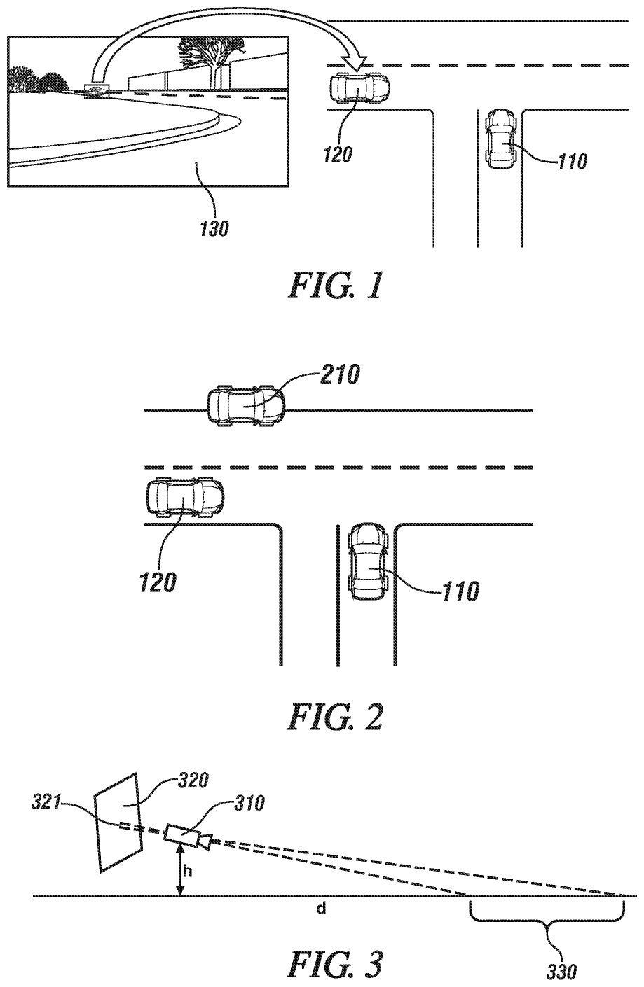

FIG. 1 illustrates a system that uses captured imagery of an object to determine the location of the object in accordance with the conventional approaches. A host vehicle 110 is attempting to accurately determine the location of an object by using imagery of the object. Specifically, host vehicle 110 is attempting to determine the location of target vehicle 120 by capturing and analyzing a 2-dimensional image 130 that depicts the location of target vehicle 120.

FIG. 2 illustrates difficulties encountered by the conventional approaches when determining the location of the object. As illustrated in FIG. 1, a host vehicle 110 attempts to determine the location of a target vehicle 120. However, because host vehicle 110 is attempting to determine a 3-dimensional location of target vehicle 120 based merely on analysis of a 2-dimensional image, host vehicle 110 will inaccurately determine the 3-dimensional location due to the limitations of the 2-dimensional imagery. For example, based on the analysis of the captured 2-dimensional imagery, host vehicle 110 can determine an incorrect object location 210 for target vehicle 120.

FIG. 3 illustrates technical difficulties encountered by the conventional approaches when attempting to determine the location of the object by using the captured imagery of the object. When the system of host vehicle 110 captures an object within a 2-dimensional image 320 by using camera 310, if the object is located at a distance that is far away from camera 310, then the exact location of the object becomes more difficult to determine. For example, if an object location is depicted at a pixel location 321 within captured imagery 320, then the actual three-dimensional location can be located anywhere within distance range 330. In other words, when attempting to determine an actual distance between camera 310 and an object based on analyzing captured imagery 320 alone, the determined actual distance between camera 310 and the object can be anywhere within distance range 330. Therefore, when an object is located far away from camera 310, the system of the conventional approaches encounter difficulties when determining the precise location of the object within range 330.

In view of the difficulties associated with the conventional approaches, one or more embodiments use both captured imagery and map information in order to determine a location of an object within three-dimensional space. The map information can include paths that the object can travel upon or be positioned upon. Each path of the map information can be segmented into map segments, as described in more detail herein.

With one or more embodiments, a system first captures the object with imagery. Next, the system analyzes the imagery to determine a location of the object as reflected by the imagery. Next, one or more embodiments determines one or more map segments of the map information that correspond to the location of the object as reflected by the imagery. In other words, in contrast to the conventional approaches of directly associating a location of the object (as reflected by the imagery) to a three-dimensional location, one or more embodiments associate a location of the object (as reflected by the imagery) to a map segment of map information. Upon associating an object location (as reflected by the imagery) to a map segment, one or more embodiments can then associate the object location (as reflected by the imagery) to a location within the map segment. Finally, as the object is associated to a location within the map segment, the location of the object in 3-dimensional space is determined based on the location within the map segment.

In order to more accurately determine the location of the object in three-dimensional space, one or more embodiments can operate on a set of assumptions. For example, one or more embodiments can operate on the assumption that the object is positioned on the ground. Specifically, if the object is a vehicle, then one or more embodiments assumes that the vehicle is driving on the ground. One or more embodiments can also operate on the assumption that the ground is flat. One or more embodiments can also operate on the assumption that the height of a camera that captures the imagery is positioned at a fixed height.

As described above, the map information can include paths that the object can travel upon or be positioned upon, where each path of the map information can be segmented into map segments. Each segment can correspond to one or more predetermined lengths. For example, each segment can correspond to a length of five to 10 meters that is reflected in the map information. One or more of these map segments can be associated with the location of an object.

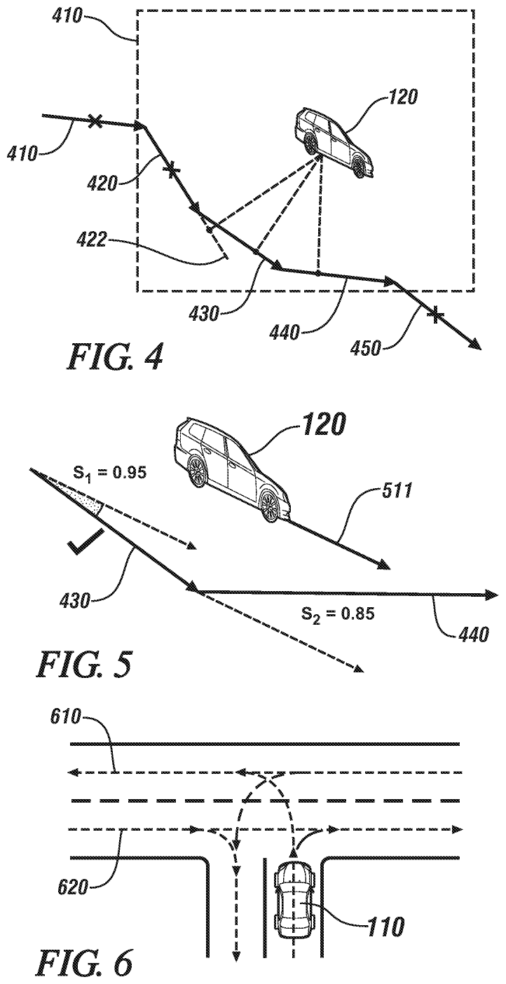

FIG. 4 illustrates associating path segments (410, 420, 430, 440, and 450) with a location of an object 120 (as reflected by the captured imagery) in accordance with one more embodiments. One or more embodiments determine which one of path segments (410, 420, 430, 440, and 450) should be associated with the location of object 120. First, one or more embodiments can remove map segments from consideration which cannot correspond to the location of object 120 (as reflected by the captured imagery). For example, segments outside of a boundary 410 can be removed from further consideration from being associated with the object location. Segments outside of boundary 410 can correspond to the segment paths that are not captured within the imagery, for example. In the example of FIG. 4, segment 410 and segment 450 are outside of boundary 410. As such, segment 410 and segment 450 can be removed from further consideration for being associated with the location of object 120 (as reflected by the captured imagery).

Further, if one or more map segments are duplicated within the map information, the system in one or more embodiments can remove duplicate map segments. Of the remaining segments (420, 430, and 440), one or more embodiments can further determine which one of the segments should be associated to the location of object 120 (as reflected by the imagery).

Referring again to FIG. 4, one or more embodiments can determine which of the remaining map segments (420, 430, and 440) that the location of the object 120 (as reflected by the imagery) should be associated with. For example, one or more embodiments can make such a determination based on which segment(s) are positioned at a closest distance to the location of the object 120 (as reflected by the imagery). In the example of FIG. 4, the location of object 120 is closest to segments 430 and 440. As such, segment 420 can be removed from further consideration. As such, in the example of FIG. 4, segment 430 and segment 440 can continue to be considered as segments that can possibly be associated with the location of object 120 (as reflected by the imagery). In addition, one or more embodiments can determine if a projection point of the object 120 is on a segment or, on an extension of a segment. If the projection pointe is on the extension of a segment, then this segment is removed from further consideration. For example, in FIG. 4, the projection of object 120 onto segment 420 is not on the se3gment 420 but on an extension 422 of segment 420. Therefore the segment 420 can be removed from further consideration.

FIG. 5 illustrates using a velocity vector 511 of the object 120 in order to determine which path segment to associate with the object location (as reflected by the captured imagery) in accordance with one or more embodiments. If one or more embodiments can determine a velocity of object 120, the determined velocity vector (i.e., “v”) can be used to determine which of path segment 430 or path segment 440 to associate with the object location. Suppose that object 120 is determined to move in accordance with unit vector 511. Suppose also that unit vectors represent the directions of map segment 430 and map segment 440. Unit vectors corresponding to map segments 430 and 440 can be represented as Pᵢ. For each of the segments (430 and 440) that are considered to be possible segments that the object is moving along, one or more embodiments can calculate:

Sᵢ=V·Pᵢ

The map-segment vector Pᵢ which yields the largest calculated value Sᵢ can be considered to be the map segment that the object is most likely to be moving along. In the example of FIG. 5, segment 430 yields a calculated S₁ value of 0.95, and segment 440 yields a calculated S₂ value of 0.85. Because segment 430 yields the highest S-value, the system of FIG. 5 associates object 120 to unit vector 430.

FIG. 6 illustrates using lane-direction information to associate the path segments with the object location in accordance with one or more embodiments. One or more embodiments can also determine the location of the object within three-dimensional space based on a direction that the object is moving and based on directional paths that are reflected within the segments of map information. If a movement direction of the object can be determined (i.e., if a vehicle is determined to travel in a direction at a measureable speed), then the movement direction can be used to determine which directional path that the object is moving upon.

For example, referring to FIG. 6, if an object is determined to be moving toward host vehicle 110, then one or more embodiments can determine that the object is moving along path 620 as opposed to path 610, where path 610 corresponds to a right-hand lane with a lane direction that is configured away from host vehicle 110.

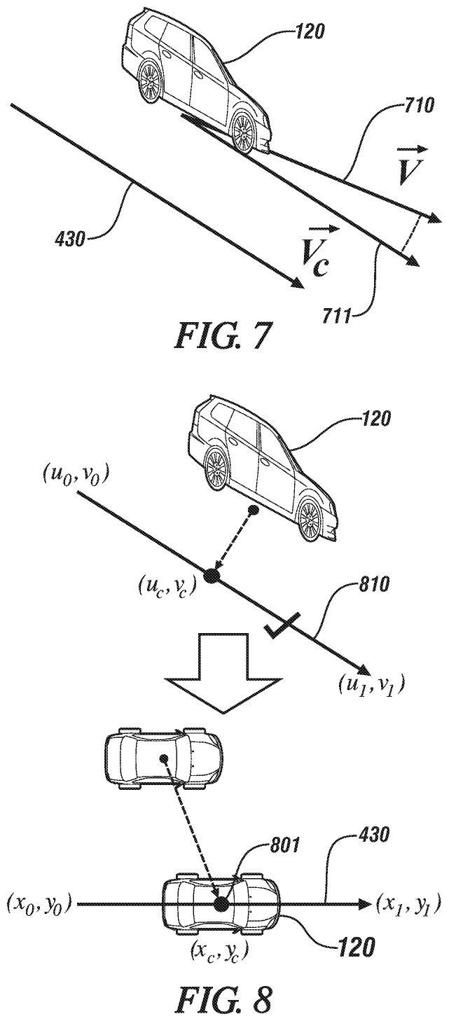

Once the object is associated with a map segment, one or more embodiments can correct a velocity vector of the object in accordance with the map segment. FIG. 7 illustrates correcting a velocity vector 710 of object 120 in accordance with one or more embodiments. Upon determining object 120 is moving along segment 430 (which corresponds to a vector of Pᵢ), then one or more embodiments can determine a corrected speed direction 711 (i.e., V_{c}) as:

V_{c}=V·Pᵢ×Pᵢ

Therefore, one or more embodiments can determine the corrected velocity (V_{c}) 711 of object 120.

As described above, upon associating a location of object 120 (as reflected by the imagery) to a map segment, one or more embodiments can then associate the object location (as reflected by the imagery) to a location within the map segment. FIG. 8 illustrates associating the object location to a location within a map segment in accordance with one or more embodiments. Similar to determining a location of object 120 (as reflected by the imagery), one or more embodiments can determine a segment path that object 120 is located upon (as reflected by the imagery). In the example of FIG. 8, suppose that object 120 is determined to be located upon segment 810 (as reflected by the imagery). Further suppose that object 120 is located at position (u_{c}, v_{c}) within segment 810 (as reflected by the imagery). Next, suppose that segment 810 within the imagery is determined to correspond to segment 430 within the map information. Suppose that the start point of segment 430 is (x₀, y₀), and suppose that the end point of segment 430 is (x₁, y₁). One or more embodiments can then determine a corrected position 801 of object 120 within segment 430 of the map information.

The corrected point 801 of the vehicle on the image (x_{c}, y_{c}) can then be calculated as:

$${x}_{c} = \frac{( {u}_{c} - {u}_{0} )}{( {u}_{1} - {u}_{0} )} ( {x}_{1} - {x}_{0} ) + {x}_{0}$$

$${y}_{c} = \frac{( {u}_{c} - {u}_{0} )}{( {u}_{1} - {u}_{0} )} ( {y}_{1} - {y}_{0} ) + {y}_{0}$$

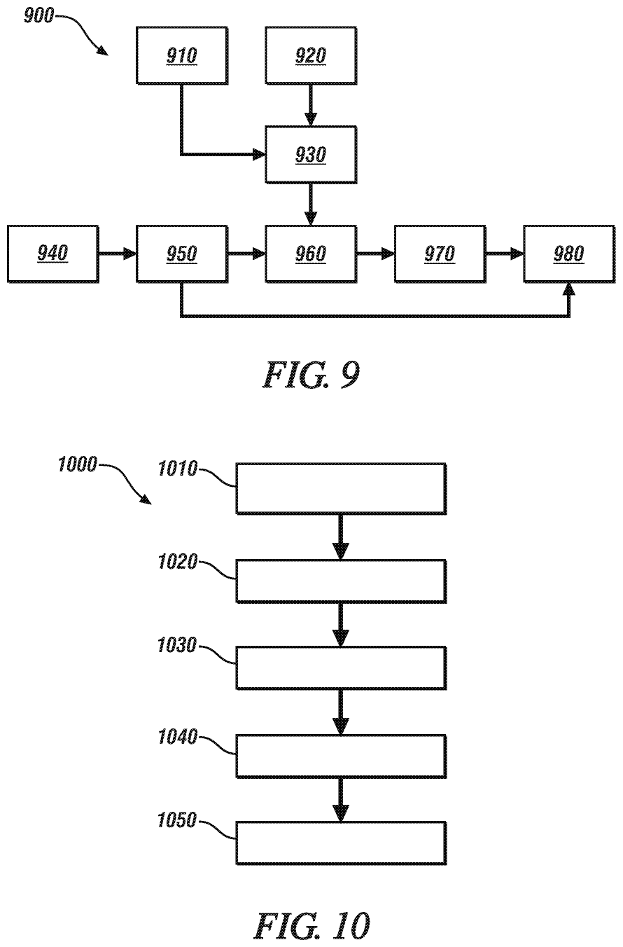

FIG. 9 illustrates a process 900 for estimating a location of an object by using map information, in accordance with one or more embodiments. At 910, a system of the host vehicle can determine the host vehicle's position. For example, the host vehicle can use a global positioning system to determine the location of the host vehicle. At 920, the system of the host vehicle can also retrieve map information regarding the area around the host vehicle. The map information includes at least one path that the object can travel upon. At 930, the system of the host vehicle can segment the at least one path of the map information into a plurality of path segments. At 940, the system of the host vehicle can use a camera to capture imagery of the object. The imagery can be 2-dimensional image, for example. At 950, the system of the host vehicle can determine whether the object is travelling at a detectable velocity from the image sequences. If the object is travelling at a detectable velocity, then the host vehicle can use the detected velocity to determine the location of the object. For example, as described above, the system of the host vehicle can use the determined velocity of the object to determine which lane of the path that the object is travelling upon. At 960, the system of the host vehicle can associate a location of the object (as reflected by the imagery) to a path segment of the map information. In contrast to the conventional approaches of directly associating a location of the object (as reflected by the imagery) to a three-dimensional location, one or more embodiments associate a location of the object (as reflected by the imagery) to a map segment of map information. At 970, the system of the host vehicle can also use a velocity vector of the object in order to associate the location of the object to the correct path segment of the map. As described above, after associating the object to a path segment, the system of the host vehicle can determine at 980, a point along the path segment where the object is located. Because the point along the path segment is associated with an actual position on the map, which reflects an actual location in 3-dimensional space, one or more embodiments can determine the actual location of the object.

FIG. 10 depicts a flowchart of a method 1000 in accordance with one or more embodiments. The method of FIG. 10 can be performed in order to determine an object location by using map information. The method of FIG. 10 can be performed by a controller in conjunction with a camera device and a global positioning system device. For example, the method of FIG. 10 can be performed by a vehicle controller that receives and processes imagery of a scene in which a vehicle is driven. The method can include, at block 1010, receiving an image data of a scene. An object is located within the scene. The method can also include, at block 1020, determining a location of the object in the image based on the image data of the scene. The method can also include, at block 1030, receiving a map information. The map information includes at least one path information. The method can also include, at block 1040, determining an association between the location of the object based on the image data and the map information of the scene. The method can also include, at block 1050, determining a 3-dimensional location of the object based on the determined association.

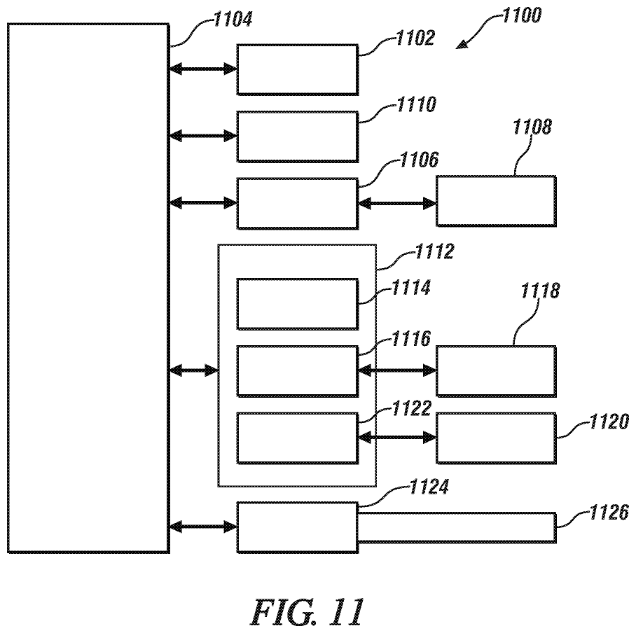

FIG. 11 depicts a high-level block diagram of a computing system 1100, which can be used to implement one or more embodiments. Computing system 1100 can correspond to, at least, a system that is configured to determine an object location by using map information, for example. The generating system can be a part of a system of electronics within a vehicle that operates in conjunction with a camera and a global positioning system, for example. With one or more embodiments, computing system 1100 can correspond to an electronic control unit (ECU) of a vehicle. Computing system 1100 can be used to implement hardware components of systems capable of performing methods described herein. Although one exemplary computing system 1100 is shown, computing system 1100 includes a communication path 1126, which connects computing system 1100 to additional systems (not depicted). Computing system 1100 and additional system are in communication via communication path 1126, e.g., to communicate data between them.

Computing system 1100 includes one or more processors, such as processor 1102. Processor 1102 is connected to a communication infrastructure 1104 (e.g., a communications bus, cross-over bar, or network). Computing system 1100 can include a display interface 1106 that forwards graphics, textual content, and other data from communication infrastructure 1104 (or from a frame buffer not shown) for display on a display unit 1108. Computing system 1100 also includes a main memory 1110, preferably random access memory (RAM), and can also include a secondary memory 1112. There also can be one or more disk drives 1114 contained within secondary memory 1112. Removable storage drive 1116 reads from and/or writes to a removable storage unit 1118. As will be appreciated, removable storage unit 1118 includes a computer-readable medium having stored therein computer software and/or data.

In alternative embodiments, secondary memory 1112 can include other similar means for allowing computer programs or other instructions to be loaded into the computing system. Such means can include, for example, a removable storage unit 1120 and an interface 1122.

In the present description, the terms “computer program medium,” “computer usable medium,” and “computer-readable medium” are used to refer to media such as main memory 1110 and secondary memory 1112, removable storage drive 1116, and a disk installed in disk drive 1114. Computer programs (also called computer control logic) are stored in main memory 1110 and/or secondary memory 1112. Computer programs also can be received via communications interface 1124. Such computer programs, when run, enable the computing system to perform the features discussed herein. In particular, the computer programs, when run, enable processor 1102 to perform the features of the computing system. Accordingly, such computer programs represent controllers of the computing system. Thus it can be seen from the forgoing detailed description that one or more embodiments provide technical benefits and advantages.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the embodiments not be limited to the particular embodiments disclosed, but will include all embodiments falling within the scope of the application.

What is claimed is:

1. A method, the method comprising:
receiving, by a controller, an image data of a scene, wherein an object is located within the scene;
determining, by the controller, a location of the object based on the image data of the scene;
receiving, by the controller, a map information, wherein the map information comprises at least one path information;
determining an association between the location of the object based on the image data and the map information of the scene; and
determining a 3-dimensional location of the object based on the determined association.

2. The method of claim 1, wherein the controller corresponds to a vehicle controller.

3. The method of claim 1, further comprising segmenting the at least one path information into a plurality of path segments.

4. The method of claim 3, wherein determining the association between the location and the map information comprises associating the location to at least one path segment.

5. The method of claim 4, wherein the map information comprises directional-path information, and the determining the association between the location of the object and the map information is based on the directional-path information.

6. The method of claim 1, further comprising determining a velocity vector of the object, wherein determining the association between the location of the object and the map information is based on the velocity vector of the object.

7. The method of claim 6, wherein determining the association comprises calculating a dot product between the velocity vector of the object and a directional vector of a segment of the at least one path information.

8. The method of claim 3, wherein determining the association between the location and the map information comprises removing at least one path segment from consideration of being associated with the location, wherein the removed at least one path segment is a path segment that is located outside of the scene.

9. The method of claim 1, wherein determining the association between the location of the object and the map information of the scene comprises associating the location of the object to a location within the map information.

10. The method of claim 9, wherein the location within the map information comprises the location within 3-dimensional space.

11. A system within a vehicle, comprising:
an electronic controller configured to:
receive an image data of a scene, wherein an object is located within the scene;
determine a location of the object based on the image data of the scene;
receive a map information, wherein the map information comprises at least one path information;
determine an association between the location of the object based on the image data and the map information of the scene; and
determine a 3-dimensional location of the object based on the determined association.

12. The system of claim 11, wherein the electronic controller corresponds to a vehicle controller.

13. The system of claim 11, wherein the electronic controller is further configured to segment the at least one path information into a plurality of path segments.

14. The system of claim 13, wherein determining the association between the location and the map information comprises associating the location to at least one path segment.

15. The system of claim 14, wherein the map information comprises directional-path information, and the determining the association between the location of the object and the map information is based on the directional-path information.

16. The system of claim 11, wherein the controller is further configured to determine a velocity vector of the object, wherein determining the association between the location of the object and the map information is based on the velocity vector of the object.

17. The system of claim 16, wherein determining the association comprises calculating a dot product between the velocity vector of the object and a directional vector of a segment of the at least one path information.

18. The system of claim 13, wherein determining the association between the location and the map information comprises removing at least one path segment from consideration of being associated with the location, wherein the removed at least one path segment is a path segment that is located outside of the scene.

19. The system of claim 11, wherein determining the association between the location of the object and the map information of the scene comprises associating the location of the object to a location within the map information.

20. The system of claim 19, wherein the location within the map information comprises the location within 3-dimensional space.
